(19) United States
(12) Patent Application Publication
(10) Pub. No.: US 2009/0026213 A1
(43) Pub. Date: Jan. 29, 2009

(54) Container with integrally insulating holder

(76) Inventor: Christian McCarthy, New York, NY (US)

Correspondence Address: Thelma A. Chen Cleland, 65 Beech Tree Lane, Monroe, CT, 06468, US

(21) Appl. No.: 11/881,655

(22) Filed: Jul. 28, 2007

(51) Int. Cl. B65D 81/38; B31B 1/00; B65D 3/28

(52) U.S. Cl. 220/592.2; 229/403; 493/84

(57) ABSTRACT

A container or cup for holding hot beverages or fluids is provided. The container consists of an integrally designed insulating portion which is structurally configured and positioned on the wall of the cup and is separated from the cup when rotated and used in conjunction with hot fluids.

### BACKGROUND

All references cited in this specification, and their references, are incorporated by reference herein in their entirety where appropriate for teachings of additional or alternative details, features, and/or technical background.

In embodiments disclosed herein there is a container with an integrally attached container holder, and a method for insulating beverage containers and container stock material. In particular, the invention relates to an insulated, paper-based beverage container having an insulating portion having an improved insulating mechanism over the prior art. The container and holder are useful for retaining hot fluids within, such as coffee, without the need for providing the container with independent sleeves for insulation that are made of a disposable material.

Commercially available containers for dispensing hot beverages such as coffee in the fast food industry, are made of diverse types of plastic, foam, paper materials and the like, however, disposable material such as plastics and paper-based are preferred. Various types of insulated metal and plastic cups are difficult and expensive to manufacture. Paper cups on the other hand are useful, however, the cups are hard to handle by the consumer when filled with hot beverages or fluid due to heat conduction from the hot fluid transferring to the container wall. Consumers can be burned when handling such cups.

In order to solve the problem with handling paper cups for use with hot beverages or fluids, the industry has produced various types of paper cups. One commercially available container for handling hot fluids is a cup with handles attached to the body of the cup. The paper handles are designed and manufactured separately from the cup and glued onto the cup at a later stage during manufacture. The handles are pulled out from the cup body at the time of use prior to or after receiving the hot food or liquid. The handles extend from the main body of the cup during use. In use, the paper handles can bend or rip with the weight of the fluid in the cup, causing hot fluid spillage and potential hazard to the consumer or the establishment serving the hot food or beverages.

A presently popular method used to insulate containers or cups with hot food or fluids is a sleeve primarily made of corrugated paper or other insulating material which is placed over the outside of the cup and which remains in tight contact with the containers. For example, U.S. Pat. No. 5,909,821 discloses a tubular beverage container insulator apparatus made out of a foam material, which can wrap around a container for insulation. U.S. Pat. Nos. 4,720,023 and 5,467,891 disclose a tubular beverage container insulator for insulating, for example, soda or beer cans. U.S. Pat. No. 6,663,926 discloses a heat-insulating container for used for an instant dried food with a heat-insulating property and design. U.S. Pat. No. 5,385,260 discloses a disposable paper cup assembly system for use with cold and hot fluids. When the paper cup is used with hot fluids, however, the retailer or consumer must add an insulating sleeve over the bottom of the cup. The disposable container is frustoconical in shape and the insulating sleeve has a smaller diameter than the widest diameter of the corresponding cup, which it is intended to go over.

This method of insulation of cups containing hot fluids has some deficiencies. Due to the fact that the cups cannot be stacked with the sleeves on them the cup, full of hot fluids, is often provided to a consumer without the sleeve. Thus the consumer must independently find and place the sleeve over the hot container by himself/herself In this process, it is possible that the customer can be burned while locating or placing the insulating sleeve over the container. Additionally, hot fluid may spill causing other problems for the establishment serving the hot beverages. Further, this method provides efficient insulation as the sleeve is in direct contact with the cup. Another deficiency of this method is that the sleeve is often made by different manufacturers and generally from different materials than the paper cup thereby increasing its cost. Therefore, there is a need to develop a container for hot beverages which facilitates the process of dispensing hot beverages in a safe manner.

### SUMMARY

A container or cup for holding hot beverages or fluids is provided, wherein the container or cup comprises an integrally built-in insulating mechanism for easily and safely drinking and handling hot foods or beverages by a consumer. In one embodiment, the container comprises a disposable paper cup with an integrally constructed mechanism attached thereto. The paper cups can be made of different sizes and in various shapes as those commercially available in the beverage industry.

In one embodiment, the paper container or cup comprises a cup body or receptacle having a somewhat cylindrical wall or frustoconical shape having an inner cavity and an exterior surface, a closed base portion, an insulating portion, and optionally a lid. The lid can be provided separately from the container. In this and other embodiments of the invention, the insulating portion is integrally, designed to be operationally configured to wrap around the container body so as to allow stacking of multiple containers in their unused state.

In one embodiment, a container is provided comprising a body portion and an insulating portion, said insulating portion is operably configured to rest adjacent to the body of said container, which can move from a position adjacent or flushed to the body of the container to a second position wherein the outer portion of the insulating portion rests away from the container body when in use with hot fluids so that a space resides between the container body wall and the insulating portion of the container. In this embodiment of the invention, the container body portion and the insulating portion can comprise various materials such as a paper material. In one embodiment, the container can further include a lid. The insulating portion of the container can be operably configured to rotate or be pushed downwardly or twisted during assembly for deployment of the insulating device on the cup prior to use.

The insulating mechanism can comprise a plurality of structural extensions or projections having a uniform size and length extending from the exterior surface of the cylindrical container. The structural extensions or projections extending from the outer surface of the container are structurally configured to contact an outer sleeve-like structure having a larger diameter than the container or cup, but is shorter in length than said container. In this embodiment, the cup insulating mechanism is integrally formed from the exterior surface of the cup and can be made from, for example, paper having the plurality of structures of the same size, the same length, the same configuration, strong structural support and can lay flat against the exterior surface of the cup. Each structural projection extending from the exterior surface of the container is in direct contact with an outer collapsible sleeve-like or somewhat cylindrical structure.

In another embodiment, a container comprising a body portion and an insulating portion is provided, wherein said insulating portion is operably configured to rest adjacent to the body of said container in a stackable configuration, and moveable from a position adjacent to said body of said container to a second position away from the container body to form a support portion of said container. In this embodiment, the insulating portion is extended away from the body by support structures projecting from the body about 90 degrees. The body and insulating portion of the container is made of durable, disposable, non-toxic paper products available in the art.

The invention is also directed to methods of manufacturing containers with integrated insulation.

### BRIEF DESCRIPTION OF THE DRAWINGS

FIG. 1 illustrates an overview of a container embodiment with an integrally constructed insulating mechanism of the invention showing the container with the insulating mechanism as manufactured, in a collapsed form.

FIG. 2 illustrates the container embodiment illustrated in FIG. 1, wherein the insulating portion is being deployed.

FIG. 3 illustrates the container embodiment depicted FIGS. 1 and 2 wherein the insulating portion is fully deployed or unraveled from the wall of the cup.

FIG. 4 illustrates the container embodiment depicted in FIG. 3 from a side or lateral view.

FIG. 5 illustrates a side view of a container embodiment with an integrally constructed insulating mechanism of the invention.

FIGS. 6-8 illustrate a side view of a container embodiment with an integrally constructed insulating mechanism of the invention showing deployment of the insulating portion of the container.

### DETAILED DESCRIPTION

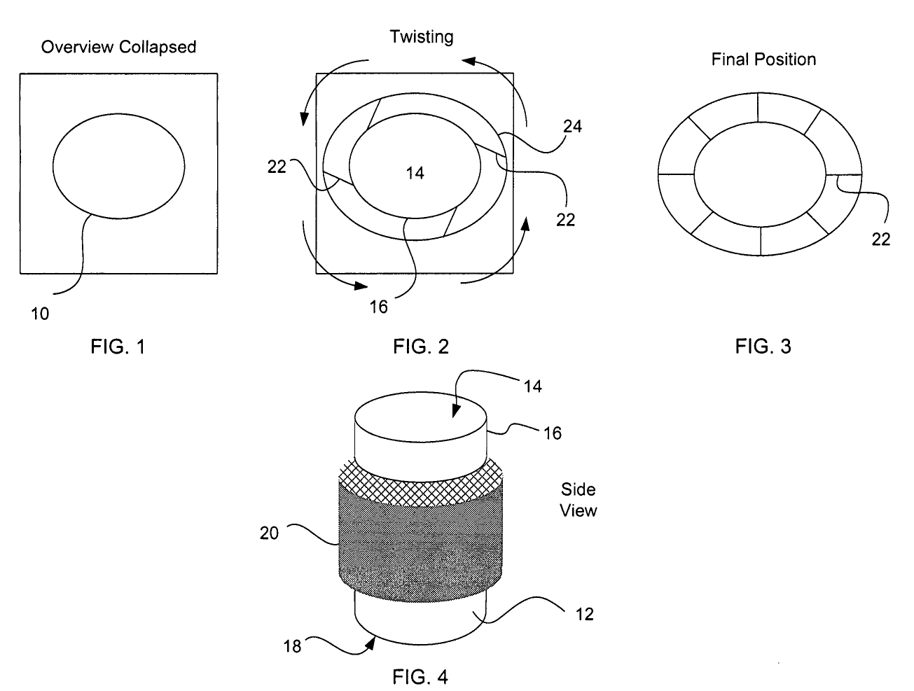

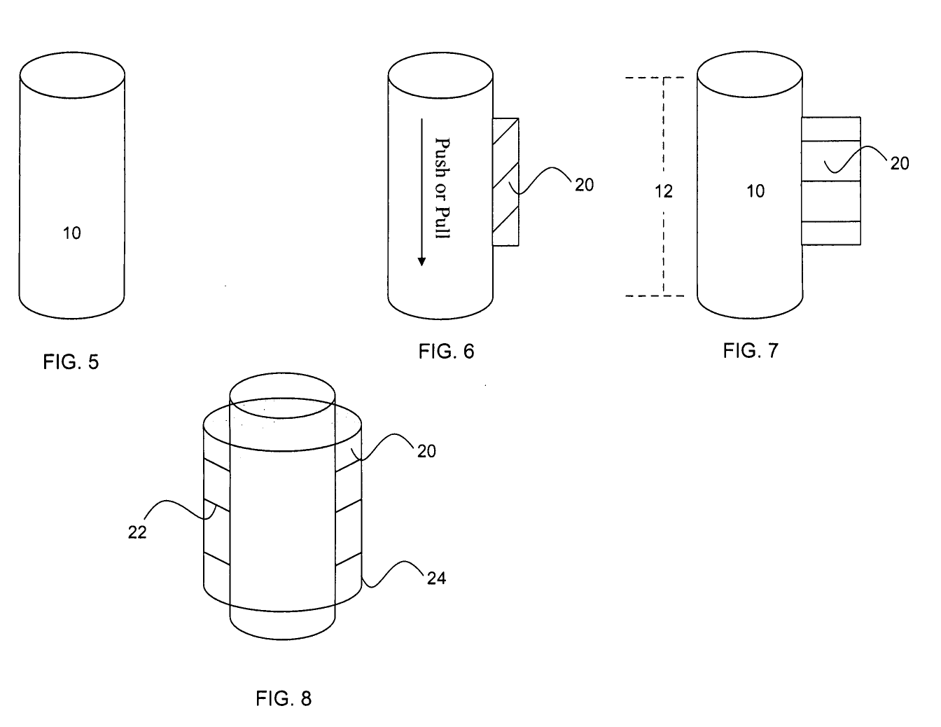

In embodiments illustrated herein, there is a container as shown in FIGS. 1-8 with integrally formed insulating member. In one embodiment, the paper container or cup 10 comprises a cup body or receptacle 12 having a cylindrical wall or frustoconical shape having an inner cavity 14 for holding fluid and an exterior surface 16, a closed base portion 18, an insulating portion 20, and optionally a lid. The lid can be provided separately from the container. In this and other embodiments of the invention, the insulating portion 20 is integrally designed to be operationally configured to wrap around the container body 12 so as to minimally affect stacking of multiple containers in their unused state.

The insulating mechanism can comprise a plurality of structural extensions or projections 22 having a uniform size and length, which can extend outwardly from the exterior surface of the cylindrical container 16. The structural extensions or projections 22 such as columns can extend outwardly from the outer surface 16 of the container 10 are structurally configured to contact an outer sleeve-like structure 24 having a larger diameter than the container or cup 10, but it can be shorter in length than said container 10. In this embodiment, the cup insulating mechanism 20 is integrally formed from the exterior surface of the cup 16 and can be made from, for example, paper having the plurality of structures 22 of the same size, the same length, the same configuration, strong structural support and can lay flat against the exterior surface of the cup. Each structural projection 22 extending from the exterior surface of the container is in direct contact with an outer collapsible sleeve-like or somewhat cylindrical structure 24. After deployment of the insulating portion of the cup, the structural projections can form support columns for the receptacle. Spaces between the support columns serve to separate the insulating portion from the cup, which prevents the heat transfer from the food or fluid to the consumer's hands.

The final position is held by a shorter column, which restricts the other columns from continuing to rotate to a collapsed position. When the shortest column is fully deployed it holds the other columns at a 90 degree angle to the surface of the cup. To prevent the protective layer from collapsing back, one end of the outer ring will reach a basic latch on the cup's surface only reachable when the outer ring is fully deployed.

The figures provided herewith depict embodiments that are described as illustrative examples that are not deemed in any way as limiting the present invention.

While the invention has been particularly shown and described with reference to particular embodiments, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

I claim:

1. A container comprising a body portion and an insulating portion, said insulating portion is operably configured in a first position to rest adjacent to said body of said container in a stackable configuration, and moveable from said first position adjacent to said body of said container to a second position away from said container body to form a support and an insulating portion of said container.

2. The container of claim 1, wherein the container body portion comprises a paper material.

3. The container of claim 1, wherein the container further comprises a detachable lid.

4. The container of claim 1, wherein the insulating portion of the container is operably configured to rotate during assembly of the cup prior to use.

5. A method for the manufacturing of the container of claim 1, comprising:
forming an insulating portion of said container integrally attached to said container outer surface; said container having a fructoconical shape; wherein said insulating portion is structurally configured to rotate from a first position to a second position, and supports the weight of said cup.

6. A container comprising a plurality of long columns and a plurality of short column, wherein said short columns are operably configured to restrict the long columns from rotating beyond a determine position to prevent collapse when the short columns are fully deployed.

7. The container of claim 6, wherein said short columns hold the long columns at an angle of about 90 degrees.

8. The container of claim 1, further comprising a latch.
